(19) United States
(12) Patent Application Publication
(10) Pub. No.: US 2014/0014460 A1
(43) Pub. Date: Jan. 16, 2014

(54) DRY CLUTCH FRICTION PLATE ASSEMBLY

(71) Applicant: JOHN M. KREMER, STERLING HEIGHTS, MI (US)

(72) Inventor: JOHN M. KREMER, STERLING HEIGHTS, MI (US)

(73) Assignee: GM GLOBAL TECHNOLOGY OPERATIONS LLC, DETROIT, MI (US)

(21) Appl. No.: 13/547,835

(22) Filed: Jul. 12, 2012

(51) Int. Cl. F16D 13/64

(52) U.S. Cl. 192/107 R

(57) ABSTRACT

A friction plate assembly for use in a dry clutch, the friction plate assembly includes a hub and support member, a first friction disc, a second friction disc, and a plurality of silicone-based adhesive beads disposed between each of the first friction disc and the second friction disc. The adhesive beads are disposed in a pattern designed to create a cooling air pathway from the interior of the friction plate assembly to the exterior.

### FIELD

The present invention relates generally to clutches for use in multiple speed transmissions and more particularly to dry clutch friction plates for use in clutches.

### BACKGROUND

The statements in this section merely provide background information related to the present disclosure and may or may not constitute prior art.

A typical dry dual clutch assembly includes at least one friction disc for each clutch. The friction discs include a friction material adhered to the facing of a steel backing plate of the disc. Through normal operation, the heat energy generated by clutch engagement increases the temperature of the friction material of the friction disc. Additionally, the coefficient of friction of the friction material is highly temperature dependent with increasing temperatures causing inconsistency in operating performance. Operating the clutch assembly at a consistently lower temperature would improve the friction performance of the assembly as well as extend the useful life of the friction material.

Accordingly, there is room in the art for an improved dry dual clutch assembly having friction discs with a cooling mechanism for consistent operational performance and extended friction material life.

### SUMMARY

A friction plate assembly if provided for use in a dry clutch, the friction plate assembly includes a hub and support member, a first friction disc, a second friction disc, a plurality of rivets, and a plurality of adhesive beads. The hub and support member includes a first axial side, a second axial side, and a first plurality of rivet bores disposed on an outer periphery. The first friction disc includes a second plurality of rivet bores disposed on an inner periphery and aligned with the first plurality of bores of the hub and support member. The first friction disc is disposed on the first axial side of the hub and support member. The second friction disc includes a third plurality of rivet bores disposed on an inner periphery and aligned with the first plurality of bores of the hub and support member and the second plurality of bores of the first friction disc. The second friction disc is disposed on the second axial side of the hub and support member. One of the plurality of rivets is disposed in each of the aligned plurality of bores of the hub and support member, the first friction disc, and the second friction disc. The plurality of adhesive beads are disposed between and in contact with each of the first friction disc and the second friction disc. Each of the plurality of adhesive beads have first end, a second end, and a middle portion, the first end is proximate an outer periphery of the first friction disc and the second end is proximate the inner periphery of the first friction disc.

In one example of the present invention, the hub and support member further include a hub portion, a support portion, and a plurality of bores each disposed in the support portion.

In another example of the present invention, the cross section of the support portion of the hub and support member has an arcuate shape.

In yet another example of the present invention, the support portion of the hub and support member and the second friction disc form an internal cavity.

In yet another example of the present invention, the internal cavity communicates with the plurality of bores of the support portion.

In yet another example of the present invention, the plurality of adhesive beads, the inner surface of the first friction disc, and the inner surface of the second friction disc form a plurality of air cooling ducts.

In yet another example of the present invention, each of the plurality of air cooling ducts communicate with the internal cavity.

In yet another example of the present invention, the first friction disc is capable of axial movement with respect to the second friction disc.

In yet another example of the present invention, the middle portion of each of the plurality of adhesive beads has an arcuate shape.

In yet another example of the present invention, the each of the plurality of adhesive beads have a composition comprising predominantly of silicone.

Further features and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way;

FIG. 1 is a cross-section view of a dual clutch torque transmitting assembly in accordance with an example of the present invention;

FIG. 2 is an axial view of a clutch friction plate assembly in accordance with an example of the present invention;

FIG. 3 is a cross section view of a clutch friction plate assembly in accordance with an example of the present invention; and

FIG. 4 is an axial interior view of a clutch friction plate assembly in accordance with an example of the present invention.

### DETAILED DESCRIPTION

The following description is merely exemplary in nature and is not intended to limit the present disclosure, application, or uses.

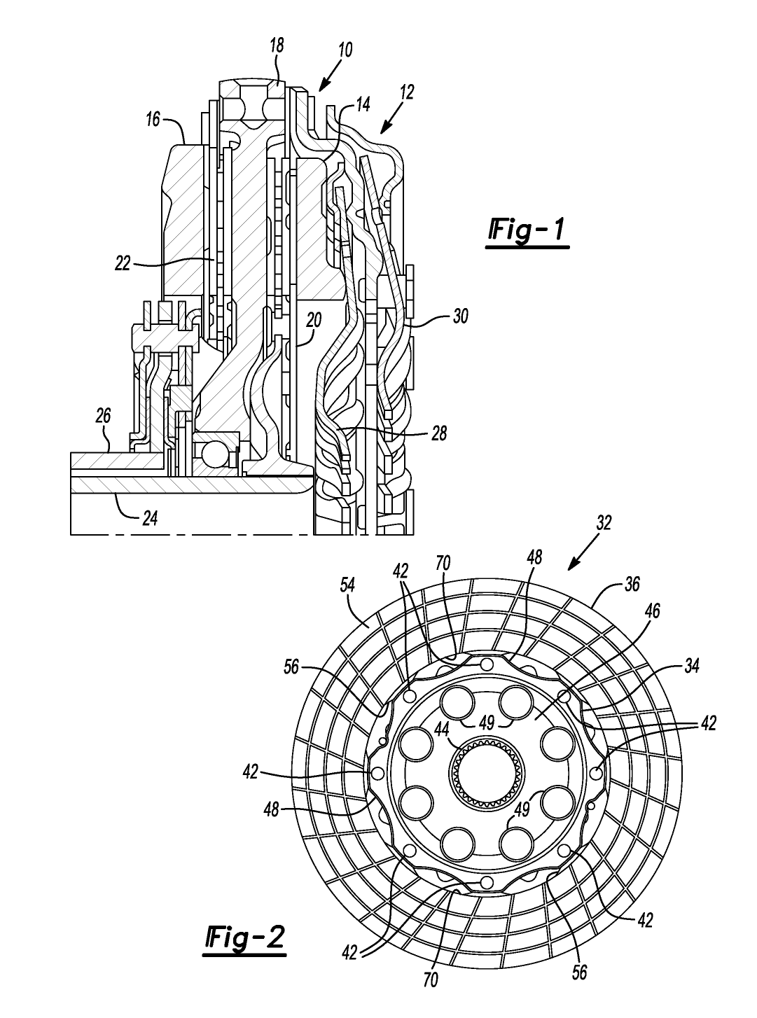

Referring to the drawings, wherein like reference numbers refer to like components, in FIG. 1 a radial view of a dual clutch torque transmitting assembly 10 is illustrated in accordance with an example of the present invention and will now be described. The dual clutch torque transmitting assembly 10 includes an input assembly 12, a first and a second clutch apply member or disc 14, 16, a clutch backing member 18, a first and a second clutch friction plate assembly 20, 22 and a first and a second transmission input member or shaft 24, 26. The input assembly 12 is rotatably driven by, for example, a flywheel or other type engine output member (not shown). The first and second clutch apply members 14, 16 are in turn rotatably driven by the input assembly 12 and are capable of axial movement via actuation of a first and a second spring plate 28, 30 of the input assembly 12. The first clutch friction plate assembly 20 is disposed axially between the first clutch apply member or disc 14 and the clutch backing member 18 and is connected by a splined interface to the first transmission input shaft or member 24. The second clutch friction plate assembly 22 is disposed axially between the second clutch apply member or disc 16 and the clutch backing member 18 and is connected by a splined interface to the second transmission input shaft or member 26. When actuated, the first spring plate 28 leverages the first clutch apply member 14 to axially compress the first clutch friction plate assembly 20 against the clutch backing member 18. Once sufficient force is applied to the first spring plate 28 of the input assembly 12 the first clutch friction plate assembly 20 and the clutch backing member 18 rotate at a common speed thus transferring torque from the engine output (not show) to the first transmission input shaft or member 24. Also, upon actuation of the second spring plate 30 the second clutch apply member 16 is leveraged to axially compress the second clutch friction plate assembly 22 against the clutch backing member 18. Once sufficient force is applied to the second spring plate 30 of the input assembly 12 the second clutch friction plate assembly 22, and the clutch backing member 18 rotate at a common speed thus transferring torque from the engine output (not show) to the second transmission input shaft or member 26.

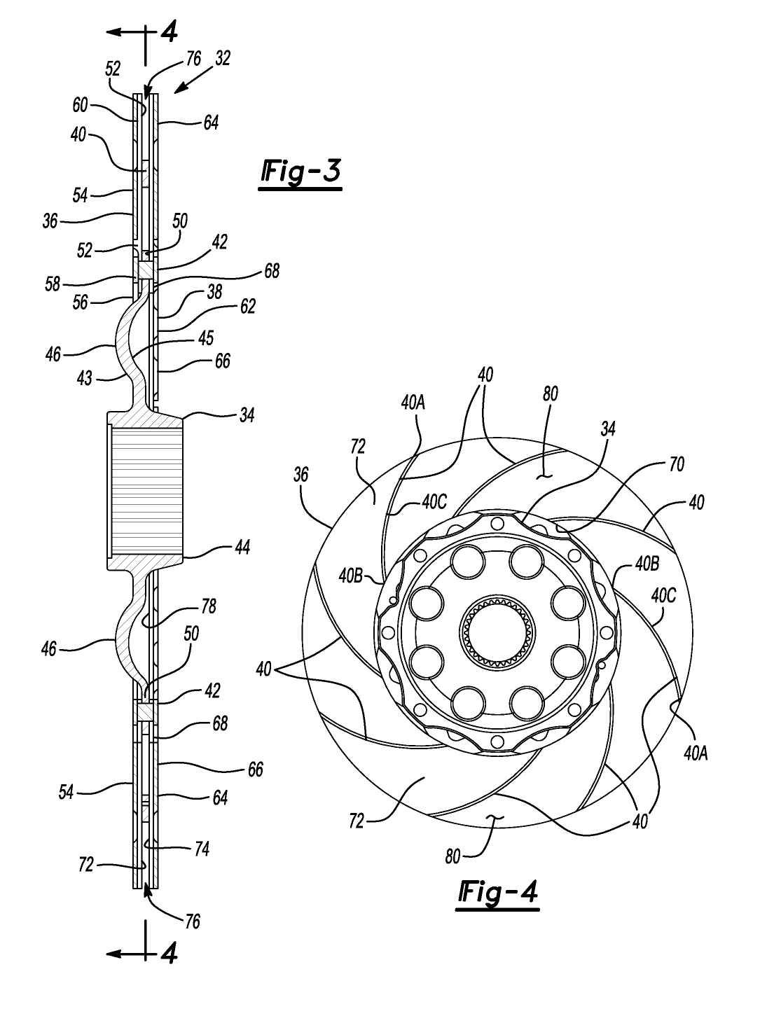

Referring now to FIGS. 2 and 3, an example a friction plate assembly 32 according to the present invention is illustrated and will now be described. The friction plate assembly 32 includes a hub and support member 34, a first friction disc 36, a second friction disc 38, an adhesive 40, and a plurality of disc rivets 42. The hub and support member 34 is disposed between the first friction disc 36 and the second friction disc 38. The hub and support member 34, the first friction disc 36, and the second friction disc 38 are fastened together by the plurality of disc rivets 42. The disc rivets 42 provide for limited axial movement between each of the friction discs 36, 38 and the hub and support member 34. The adhesive 40 of the friction plate assembly 32 is in the form of a plurality of adhesive beads 40 disposed in contact with and between the first and second friction discs 36, 38. The adhesive beads 40 helps prevent excessive relative movement between the first and second friction discs 36, 38 while providing a cushion against the compressive force applied to each of the friction discs 36, 38 by the clutch apply members 14, 16 and the clutch backing member 18.

The hub and support member 34 of the friction plate assembly 32 includes a first axial side 43, a second axial side 45, a hub portion 44, a support portion 46 and a plurality of rivet tabs 48. The hub portion 44 is splined for connection to a transmission input shaft or member (shown as 24 in FIG. 1). The support portion 46 is disposed on the outer periphery of the hub portion 44 and includes a plurality of axial bores 49. The bores 49 provide both a weight savings and a breathing passage for air from the outside of the friction plate assembly 32. The plurality of rivet tabs 48 are disposed equally spaced on the outer periphery of the support portion 46 and each of the plurality of rivet tabs 48 include a bore 50.

The first friction disc 36 of the friction plate assembly 32 includes a backing plate 52 and a friction face 54. The backing plate 52 includes a plurality of rivet tabs 56 disposed equally spaced on the inner periphery of the backing plate 52 and each of the plurality of rivet tabs 56 include a bore 58 that is axially aligned with one of the bores 50 of the rivet tabs 48 of the hub and support member 34. The friction face 54 is disposed on an outer face 60 of the backing plate 52 and is radially aligned with the first apply member 16.

The second friction disc 38 of the friction plate assembly 32 includes a backing plate 62 and a friction face 64. The friction face 64 is disposed on an outer face 66 of the backing plate 62 and is radially aligned with the first apply member 16. The backing plate 62 includes a plurality of bores 68 that are radially aligned with the bores 50, 58 of the hub and support member 34 and the first friction disc 36. One of the plurality of rivets 42 passes through each of the bores 50, 58, 68 of the hub and support member 34, the first friction disc 36, and the second friction disc 38. When assembled in this manner, the friction plate assembly 32 includes a plurality of breathing passages 70 that allow air to pass between the friction discs 36, 38 and the hub and support member 34.

With continuing reference to FIG. 3 and additional reference to FIG. 4, the interior of the friction plate assembly 32 is illustrated and will now be described. The friction plate assembly 32 further includes a cooling air pathway 76 that allows air to enter into the interior of the friction plate assembly 32 and exit on the outer periphery of the friction plate assembly 32. The cooling air pathway 76 includes the plurality of bores 49 in the support portion 46 of the hub and support member 34, the plurality of breathing passages 70, an internal cavity 78, and a plurality of ducts 80. The internal cavity 78 is formed between an inner surface of the support portion 46 and an inner surface of the second friction disc 38. The plurality of ducts 80 are formed by an inner face 72 of the first friction disc 36, the inner face 74 of the second friction disc 38, and the plurality of adhesive beads 40. The internal cavity 78 communicates with the plurality of bores 49 of the hub and support member 34 and the plurality of breathing passages 70. The plurality of ducts 80 communicate with each of the internal cavity 78, the breathing passages 70, and the exterior of the friction plate assembly 32.

The plurality of adhesive beads 40 are disposed on the inner face 72, 74 of each of the first and second friction discs 36, 38. The composition of the adhesive of the plurality of adhesive beads 40 includes a silicone based adhesive although other adhesives may be used without departing from the scope of the invention. The plurality of adhesive beads 40 form a “pinwheel” or “turbine” pattern while each of the plurality of adhesive beads includes a first end 40A, a second end 40B, and a middle portion 40C. The first end 40A of each of the plurality of adhesive beads 40 is disposed near the outer periphery of the first friction disc 36. The second end 40B of each of the plurality of adhesive beads 40 is disposed near the inner periphery of the first friction disc 36. The middle portion 40C of each of the plurality of adhesive beads 40 has an arcuate shape, however, a straight middle portion 40C or another shape of the middle portion 40C may be considered without departing from the scope of the present invention. As the friction plate assembly 32 spins, the pattern of the adhesive beads 40 encourages a flow of air from the internal cavity 78 of the friction plate assembly 32 to the outer periphery of the friction plate assembly 32 by creating a low pressure zone at the outer periphery and a high pressure area in the internal cavity 78 of the friction plate assembly 32. The combined difference in air pressure creates the airflow through the cooling air pathway 76 and thus removes the hot air from between the friction discs 36, 38 and provides fresh cooling air to remove additional heat from the friction discs 36, 38 thus allowing for lower operating temperatures of the friction faces 54, 64 which result in improved and more consistent operating conditions and longer friction face 54, 64 life. Whereas this example of the present invention utilizes the “pinwheel” or “turbine” pattern of adhesive beads, other patterns that encourage airflow between the friction discs 36, 38 may be considered without departing from the scope of this invention.

The description of the invention is merely exemplary in nature and variations that do not depart from the gist of the invention are intended to be within the scope of the invention. Such variations are not to be regarded as a departure from the spirit and scope of the invention.

What is claimed is:

1. A friction plate assembly for use in a dry clutch, the friction plate assembly comprising:
a hub and support member having a first axial side, a second axial side, and a first plurality of rivet bores disposed on an outer periphery;
a first friction disc having a second plurality of rivet bores disposed on an inner periphery and aligned with the first plurality of bores of the hub and support member, and wherein the first friction disc is disposed on the first axial side of the hub and support member;
a second friction disc having a third plurality of rivet bores disposed on an inner periphery and aligned with the first plurality of bores of the hub and support member and the second plurality of bores of the first friction disc, and wherein the second friction disc is disposed on the second axial side of the hub and support member;
a plurality of rivets wherein one of the plurality of rivets is disposed in each of the aligned plurality of bores of the hub and support member, the first friction disc, and the second friction disc; and
a plurality of adhesive beads disposed between and in contact with each of the first friction disc and the second friction disc, and wherein each of the plurality of adhesive beads have first end, a second end, and a middle portion, the first end is proximate an outer periphery of the first friction disc and the second end is proximate the inner periphery of the first friction disc.

2. The friction plate assembly of claim 1 wherein the hub and support member further include a hub portion, a support portion, and a plurality of bores each disposed in the support portion.

3. The friction plate assembly of claim 2 wherein the support portion of the hub and support member and the second friction disc form an internal cavity.

4. The friction plate assembly of claim 3 wherein the internal cavity communicates with the plurality of bores of the support portion.

5. The friction plate assembly of claims 4 wherein the plurality of adhesive beads, the inner surface of the first friction disc, and the inner surface of the second friction disc form a plurality of air cooling ducts.

6. The friction plate assembly of claim 5 wherein each of the plurality of air cooling ducts communicate with the internal cavity.

7. The friction plate assembly of claim 6 wherein the cross section of the support portion of the hub and support member has an arcuate shape.

8. The friction plate assembly of claim 1 wherein the first friction disc is capable of axial movement with respect to the second friction disc.

9. The friction plate assembly of claim 1 wherein the middle portion of each of the plurality of adhesive beads has an arcuate shape.

10. The friction plate assembly of the claim 1 wherein the each of the plurality of adhesive beads have a composition comprising predominantly of silicone.

11. A friction plate assembly for use in a dry clutch, the friction plate assembly comprising:
a hub and support member having a first axial side, a second axial side, and a first plurality of rivet bores disposed on an outer periphery;
a first friction disc having a second plurality of rivet bores disposed on an inner periphery and aligned with the first plurality of bores of the hub and support member, and wherein the first friction disc is disposed on the first axial side of the hub and support member;
a second friction disc having a third plurality of rivet bores disposed on an inner periphery and aligned with the first plurality of bores of the hub and support member and the second plurality of bores of the first friction disc, and wherein the second friction disc is disposed on the second axial side of the hub and support member;
a plurality of rivets wherein one of the plurality of rivets is disposed in each of the aligned plurality of bores of the hub and support member, the first friction disc, and the second friction disc, and the first friction disc is capable of axial movement with respect to the second friction disc; and
a plurality of silicone-based adhesive beads disposed between and in contact with each of the first friction disc and the second friction disc, and wherein each of the plurality of adhesive beads have first end, a second end, and a middle portion, the first end is proximate an outer periphery of the first friction disc and the second end is proximate the inner periphery of the first friction disc.

12. The friction plate assembly of claim 11 wherein the hub and support member further include a hub portion, a support portion, and a plurality of bores each disposed in the support portion.

13. The friction plate assembly of claim 12 wherein the support portion of the hub and support member and the second friction disc form an internal cavity.

14. The friction plate assembly of claim 13 wherein the internal cavity communicates with the plurality of bores of the support portion.

15. The friction plate assembly of claims 14 wherein the plurality of adhesive beads, the inner surface of the first friction disc, and the inner surface of the second friction disc form a plurality of air cooling ducts.

16. The friction plate assembly of claim 15 wherein each of the plurality of air cooling ducts communicate with the internal cavity.

17. The friction plate assembly of claim 16 wherein the cross section of the support portion of the hub and support member has an arcuate shape.

18. The friction plate assembly of claim 11 wherein the middle portion of each of the plurality of adhesive beads has an arcuate shape.

19. A friction plate assembly for use in a dry clutch, the friction plate assembly comprising:
a hub and support member having a first axial side, a second axial side, and a first plurality of rivet bores disposed on an outer periphery;
a first friction disc having a second plurality of rivet bores disposed on an inner periphery and aligned with the first plurality of bores of the hub and support member, and wherein the first friction disc is disposed on the first axial side of the hub and support member;
a second friction disc having a third plurality of rivet bores disposed on an inner periphery and aligned with the first plurality of bores of the hub and support member and the second plurality of bores of the first friction disc, and wherein the second friction disc is disposed on the second axial side of the hub and support member;
a plurality of rivets wherein one of the plurality of rivets is disposed in each of the aligned plurality of bores of the hub and support member, the first friction disc, and the second friction disc, and the first friction disc is capable of axial movement with respect to the second friction disc; and
a plurality of silicone-based adhesive beads disposed between and in contact with each of the first friction disc and the second friction disc, and wherein each of the plurality of adhesive beads have first end, a second end, and a middle portion, the first end is proximate an outer periphery of the first friction disc, the second end is proximate the inner periphery of the first friction disc, and the middle portion of each of the plurality of adhesive beads has an arcuate shape.

20. The friction plate assembly of claim 19 wherein the hub and support member further include a hub portion, a support portion, and a plurality of bores each disposed in the support portion.

21. The friction plate assembly of claim 20 wherein the support portion of the hub and support member and the second friction disc form an internal cavity.

22. The friction plate assembly of claim 21 wherein the internal cavity communicates with the plurality of bores of the support portion.

23. The friction plate assembly of claims 22 wherein the plurality of adhesive beads, the inner surface of the first friction disc, and the inner surface of the second friction disc form a plurality of air cooling ducts.

24. The friction plate assembly of claim 23 wherein each of the plurality of air cooling ducts communicate with the internal cavity.

25. The friction plate assembly of claim 24 wherein the cross section of the support portion of the hub and support member has an arcuate shape.
